(19) United States
(12) Patent Application Publication
(10) Pub. No.: US 2006/0268756 A1
(43) Pub. Date: Nov. 30, 2006

(54) Systems and methods for efficient hand-off in wireless networks

(75) Inventors: Yan Wang, Ma On Shan (CN); Cheong Yui Wong, Tai Po (CN); Jingyi He, Fanling (CN); Piu Bill Wong, Hong Kong (CN); J.D. Qu, Shatin (CN); Soung Chang Liew, Shatin (CN); Vincent Lau, Tseung Kwan O (CN); Paul Ho, Pokfulam (CN); Gary Jiang, Shenzhen (CN)

Correspondence Address: DALLAS OFFICE OF FULBRIGHT & JAWORSKI L.L.P., 2200 ROSS AVENUE, SUITE 2800, DALLAS, TX, 75201-2784, US

(73) Assignee: Hong Kong Applied Science and Technology Research Institute Co., Ltd., Shatin (CN)

(21) Appl. No.: 11/121,317

(22) Filed: May 3, 2005

(51) Int. Cl. H04B 7/00

(52) U.S. Cl. 370/310

(57) ABSTRACT

Embodiments of systems and methods for efficient hand-off in a wireless network employ a neighbor report which may include, in addition to more convention information about neighboring access point, search thresholds, target beacon transmission time of neighboring access points, and execution thresholds. The present systems and methods also provide a mechanism of updating neighbor report and its elements. A faster and lower spectrum cost active search scheme based on sending a null packet may also be used by the systems and methods.

### TECHNICAL FIELD

The present invention is generally related to wireless communications and more specifically to systems and methods for efficient hand-off in a wireless network.

### BACKGROUND OF THE INVENTION

FIG. 1 shows a simple structure of a typical wireless local area network (WLAN) 100, such as may comprise a Wi-Fi network. WLAN 100 has three access points (APs), (AP1, AP2 and AP3), which are interconnected through switch 101. Typically each access point employs a different communication channel in order to reduce interference relative to one another. The coverage area of each access point typically overlaps with at least one other access point in a WLAN. In illustrated WLAN 100 the coverage area of each access point overlaps to some degree with the coverage area of each of the other two access points. FIG. 1 is intended to illustrate a mobile station (STA) moving among the coverage area of different access points, such as from the coverage area of AP1 to AP2, via area 102 of overlap between the coverage areas of AP1 and AP2.

To maintain a seamless connection for the station when moving between access points 1 and 2, a hand-off scheme is typically provided. Currently, most solutions rely on the station to take action. These handoff procedures typically employ three phases, discovery, search and execution. In the discovery phase a station realizes that it needs to roam to another access point. In the search phase the station finds a suitable neighbor access point to roam to. In the execution phase the station decides which one of a number of candidate neighboring access points to roam to.

In a typical discovery phase, a station monitors the quality of its connection with its presently associated access point, typically in terms of received signal to noise ratio (SNR) and/or packet error rate. If these measures are less than a certain, typically predefined fixed, threshold, the station employs a search phase to find out whether there is one or more other access points which can provide better connection than the presently associated access point.

Typically, in the search phase, the station first sends a null packet to its associated access point with a power save mode bit setting. When the presently associated access point receives the null packet, the associated access point believes that station is in power save mode and it would buffer all packets with a destination address for that station. After sending the null packet to its presently associated access point, the station begins to scan different channels, staying in each of these different channels for a certain period of time to listen for a beacon on that channel. If the station receives a beacon signal sent by another access point, it saves the information identifying that access point contained in the beacon signal, and saves an estimated link quality for that access point (e.g. as may be measured from the received signal strength of the beacon signal). After scanning, the station goes back to its old channel and sends a power save poll packet to its presently associated access point. On receiving this power save poll packet, the access point recognizes that the station has come back from power save mode and the access point recovers packet transmission to the station, and sends any buffered packets to the station.

In such a typical searching scheme, knowledge of neighboring access points is based on the station listening for a beacon without the station conducting the search actively transmitting any packets to the non associated access points. This searching scheme is often referred to as a passive search scheme. Such a scheme does not generate any extra traffic on channels the station is not presently associated with. However, such a passive search might require appreciable time to accomplish. With attention directed to prior art FIG. 2, a typical beacon interval is 100 ms. Therefore, a station must stay on each channel at least 100 ms during a typical search in order to receive the beacon from each of the access points using the channel and to thereby determine the signal strength for each access point employing that channel. In the IEEE 802.11b/g standard Wi-Fi band, there are 11 channels. Therefore, the time required to scan the 10 channels not presently associated with the searching station can be as long as a full second.

To reduce search time, the existing standards enable a station to send a probe request packet on the channels not presently associated with the station, any access point which receives a probe request packet provides the station certain information (timestamp, beacon interval, capability information, Service Set Identification (SSID), and the like) by sending a probe response packet to station. Such a searching scheme is typically referred to as an active search scheme. Using such an active search scheme, a station can gather information about neighboring access points and estimate the link quality for the various neighboring access points from the received signal strength of the probe response packets. Still, depending on the traffic conditions on the non-associated channels, the access point response time can be several to tens of milliseconds. Therefore, the total searching time is reduced, at the expense of generating extra traffic on non-associated channels. Problematically, the extra traffic uses system capacity and as the number of stations searching for a handoff access point increases, the loss of capacity and bandwidth can become significant.

As one of ordinary skill in the art will appreciate the search phase in an 802.11b/g-based network, which has 11 channels, and in an 802.11a-based network, which has tens of channels, is quite time consuming. To reduce scanning time during the search phase, a site report, which contains information about neighboring access points, has been proposed for the draft IEEE 802.11k standard.

FIG. 3 shows the basic structure of the proposed 802.11k site report. Each element of the site report contains information about one of the sending access point's neighboring access points including the neighboring access point's Basic Service Set Identification (BSSID), BSSID match status, current channel and Physical layer type (PHY type). Under the proposed 802.11k standard, when a station needs to hand-off, the station generates a request to its associated access point. After receiving the request, the associated access point sends a site report to the station. The site report typically identifies the channels being used by neighboring access points. Therefore, under the proposed 802.11k standard, by using the site report, a station does not need to scan all channels, the required time for searching can be reduced significantly. However, the proposed 802.11k standard's use of a site report does not consider various application and station requirements, and can still use a significant amount of bandwidth to exchange site reports, particularly with multiple stations searching for handoff access points requesting site reports from multiple access points.

The final handoff phase is typically referred to as the execution phase. With knowledge of its neighboring access points (whether obtained through passive searching, active searching, or using a site report), a station may check to determine whether one of the neighboring access points can provide better connection than the currently associated access point. If a better connection exists, the station will typically try to associate with that access point and disassociate with current access point, otherwise the station would go back to search phase and get the most up-to-date information about the neighboring access point.

Interaction of these hand-off phases, as typically implemented, produce further problems. For example, as mentioned previously, a station monitors its current link quality according to received SNR and/or packet error rate. If they breach a predefined threshold, the station searches for other neighboring access points. Problematically, signals within a service area vary in time and depending on location. With a pre-defined threshold, a station may begin to scan for neighboring access points when the station is still located in a non-overlapping area of access point coverage because the received SNR and/or packet error rate breach the pre-defined threshold due to these variations. Since another channel is not available in such non-overlapping areas, unnecessary traffic is generated on all of the non-associated channels.

Also, different applications have different requirements concerning hand-off delay and robustness. For example, a voice application has a relatively strict limitation on delay (e.g. less than 40 ms) but its requirement on link quality is relatively low. Conversely, a data application is not so sensitive to delay (e.g. the delay can be hundreds of ms) but a data application requires relatively higher quality link. As has been mentioned earlier, passive search schemes are based on a station listening for a beacon sent by a non-associated access point. As also noted above this may result in the station staying on each of the non-associated channel for a relatively significant amount of time since the beacon interval is normally 100 ms. As a result, under existing standards, delay sensitive applications, such as a voice application, that cannot tolerate such a long delay, must rely on an active searching scheme, which generates extra overhead traffic. A further problem arises in that stations moving at relatively higher speeds may not have time to conduct a search in accordance with the existing standards if the thresholds are set too high, since fast moving stations have less time in overlapping areas.

### BRIEF SUMMARY OF THE INVENTION

The present invention provides systems and methods for efficient hand-off in a wireless communications environment, especially a WLAN environment. Herein, the present systems and methods are described with reference to a WLAN. However, embodiments of the present systems and methods may be employed in a variety of network architectures including, but not limited to a wireless metropolitan network (WMAN), a wireless wide-area network, cellular networks and/or the like.

Embodiments of the present systems and methods employ a “neighbor report” which contains more information than the proposed 802.11k site report. The neighbor report is provided by an access point to its stations. The access points broadcast the neighbor report to its stations periodically and/or upon request by a station, thereby freeing network capacity by reducing or eliminating the need for a station to request a site report from a potential handoff access point and the need for such an access point to transmit the site report. Additionally, embodiments of the present system may make use of neighbor report updates, rather than re-broadcasting full neighbor reports, further reducing network overhead. Through the neighbor report the present systems and methods enable a station to enjoy a more efficient and low cost handoff.

Embodiments of the neighbor report includes a search threshold, a target beacon transmission time of neighboring access points and an execution threshold. The search threshold and the execution threshold may be adaptive thresholds based on application type, moving speed, target access point, and/or the like. Adaptive search thresholds may be used by a station to start the searching process, while the adaptive execution thresholds may be used to select the target access point. Preferably, the use of adaptive thresholds improves the handoff robustness while reducing the overhead. Regarding the thresholds for search, the search thresholds are metrics associated with a station's currently associated access point, which are decreasing as the station moves away for the access point. Therefore, a higher search threshold value results in a search starting earlier. On the other hand, a threshold for execution may be viewed in terms of the difference in the quality of a link between the currently associated access point and a potential target access point. Therefore, a higher execution threshold value might result in a later handoff.

A target beacon transmission time of neighboring access points contained in a neighbor report may be employed by embodiments of the present systems and methods to provide faster and lower spectrum cost passive searching. In accordance with embodiments of the present invention a station may switch to the channel of a potential handoff access point to receive the access point's beacon, Source Address Table (SAT) signal, pilot signal , or the like (generally referred to herein as a “beacon”) at the target beacon transmission time, rather than wasting time waiting on the channel for the beacon.

Additionally or alternatively, embodiments of the present systems and methods may employ active searching based on sending a null packet to a potential target access point and measuring the SNR, or the like, of the acknowledgement signal returned by the access point. Preferably, this results in reduced response times during an active search. For example, after receiving the null packet, the access point will transmit a Media Access Control (MAC) Acknowledgement (ACK) after a short inter-frame space time which is typically 10 microseconds. A typical probe response time to a probe request will be much longer. Additionally, use of a null packet and MAC ACK for active searching saves network bandwidth over stations requesting site reports from the potential handoff access points and the access points transmitting the site reports to each of these stations.

As noted above, different applications have different requirements concerning hand-off delay and robustness. Therefore, in accordance with embodiments of the present systems and methods a threshold used to initiate a search may be different based on the application a station is employing at any given time. For example, a higher search threshold can be set for voice station, so that a station running a voice application can start to search for other access points once the station enters an area of overlapping access point coverage and reduce the chance that the station will fail to find an access point before losing its current connection. For a data station, the search for other access points can start later so that the link quality with other access points is more likely to be better than with the current access point. As a result of using such adaptive thresholds less searching traffic is generated, freeing spectrum.

For stations moving at different speeds, a fast moving station has less time in an overlapping area. Therefore, in accordance with embodiments of the present systems and methods a fast moving station should start searching relatively early, while a slow moving station has more time in an overlapping area and can start its search later. In response the present systems and methods, preferably set a relatively high search threshold for fast moving stations, while a lower search threshold is preferably set for a slow moving station.

Embodiments of The present systems and methods also provide a more efficient passive search, by a station, with less overhead, through the use of Target Beacon Transmission Time (TBTT) information contained in a neighbor report for each neighboring access point. Further the present systems and methods provide faster and more efficient active searches by using a null packet and a Media Access Control (MAC) Acknowledgement (ACK), or similar signal recognition, returned from an access point instead of probe request and response to measure an access point's signal strength.

For the execution phase, when a station has a number of candidate target access points from which to decide to roam to, the present systems and methods preferably employ adaptive thresholds. The adaptive thresholds may, again, depend on the station's moving speed and/or the type of application being employed by a station at that time. The adaptive thresholds used for the execution phase are preferably different from the adaptive thresholds used for the discovery phase. However, the same adaptive thresholds may be used in some circumstances. Regardless, the adaptive thresholds are used in accordance with embodiments of the present invention to select a best handoff access point and thereby achieve a more stable or robust handoff.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWING

For a more complete understanding of the present invention, reference is now made to the following descriptions taken in conjunction with the accompanying drawing, in which:

FIG. 1 is a diagrammatic illustration of a prior art WLAN;

FIG. 2 is a diagrammatic illustration showing spectrum usage of at least a portion of a prior art passive search scan;

FIG. 3 is a diagrammatic illustration of a prior art proposed IEEE 802.11k site report for one neighboring access point;

FIG. 4 is a diagrammatic illustration of an embodiment of a neighbor report in accordance with the present invention;

FIG. 5 is a diagrammatic illustration of an embodiment of the use of adaptive search thresholds;

FIG. 6 a diagrammatic illustration of at least a portion of passive search scanning spectrum usage in accordance with embodiments of the present systems and methods;

FIG. 7 is a diagrammatic illustration of an embodiment of the use of adaptive execution thresholds;

FIG. 8 is a flow diagram of embodiment of a method for obtaining a neighbor report by a station in accordance with the present invention;

FIG. 9 is a flow diagram of embodiment of a method for transmitting a neighbor report by an access point in accordance with the present invention FIG. 5 is a diagrammatic illustration;

FIG. 10 is an example timeline for transmission and reception of neighbor reports from an access point to a new station in accordance with the method embodiments of FIGS. 8 and 9;

FIG. 11 is diagrammatic illustration of an embodiment of a system employing an ad-hoc method for acquiring the TBTTs of access points; and

FIG. 12 is diagrammatic illustration of an embodiment of a system employing an central controller for distributing the TBTTs of access points.

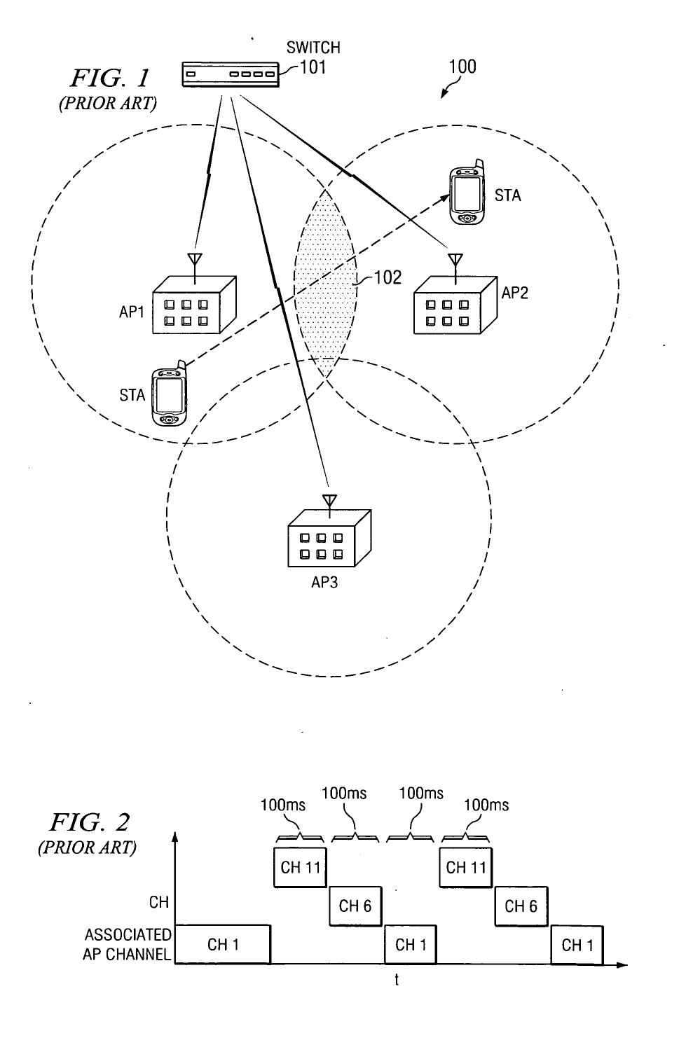

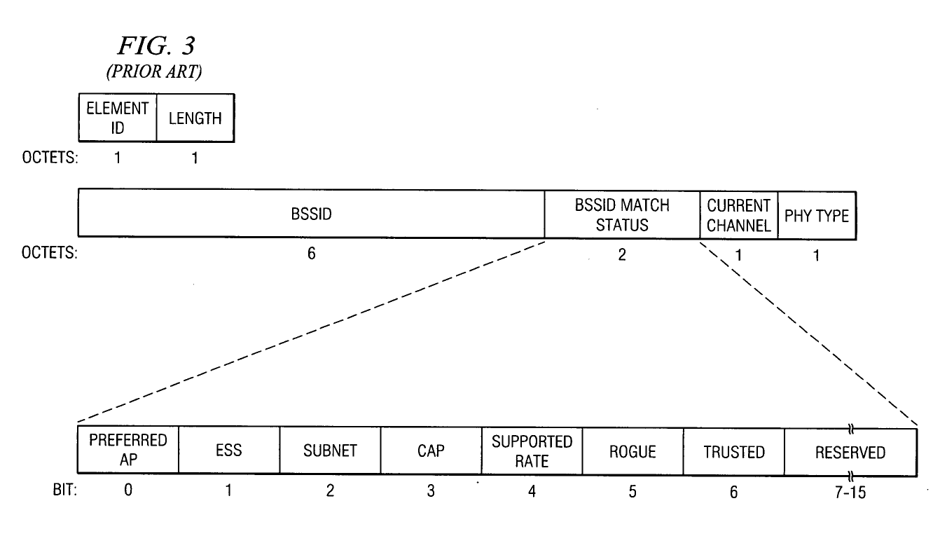

### DETAILED DESCRIPTION OF THE INVENTION

Embodiments of the present systems and methods employ a neighbor report which may, in addition to more conventional information about neighboring access point, include search thresholds, target beacon transmission time of neighboring access points, and execution thresholds. The present systems and methods also provide a mechanism of updating neighbor report. A faster and lower spectrum cost active search scheme based on sending a null packet may additionally or alternatively be used by the present systems and methods

In accordance with embodiments of the present invention, the neighbor report is provided by an access point to its stations. An access point broadcasts the neighbor report to its stations periodically and/or upon request by a station. This reduces or eliminates the need for a station to request a site report from a potential handoff access point and the need for such an access point to transmit the site report, thereby freeing network capacity. Additionally, embodiments of the present system may use shorter neighbor report updates to inform stations of neighbor access point changes, rather than re-broadcasting the entire neighbor report. This further reduces network overhead, freeing network capacity.

In accordance with embodiments of the neighbor report includes a search threshold and a execution threshold. The search threshold and the execution threshold may be adapted based on the type of application a station is running, the moving speed of the station, target access point, a currently associated access point, or other variables. In accordance with embodiments of the present invention the search threshold may be used by a station to determine when to start the searching process, while the execution thresholds may be used to select the target access point. Preferably, the use of adaptive thresholds improves the handoff robustness while reducing the overhead.

A target beacon transmission time of neighboring access points may also be contained in embodiments of a neighbor report and may be employed by embodiments of the present systems and methods to provide faster and lower spectrum cost passive searching. In accordance with embodiments of the present invention a station may switch to the channel of a potential handoff access point at the target beacon transmission time to receive the access point's beacon, rather than wasting time waiting on the channel for the beacon.

Additionally or alternatively, embodiments of the present systems and methods may employ active searching that sends a null packet to a potential target access point and measures the SNR, or other signal strength measurement, of the acknowledgement signal returned by the access point. In contrast to stations requesting site reports from the potential handoff access points and the access points transmitting the site reports to each of these stations considerable net work capacity is freed-up.

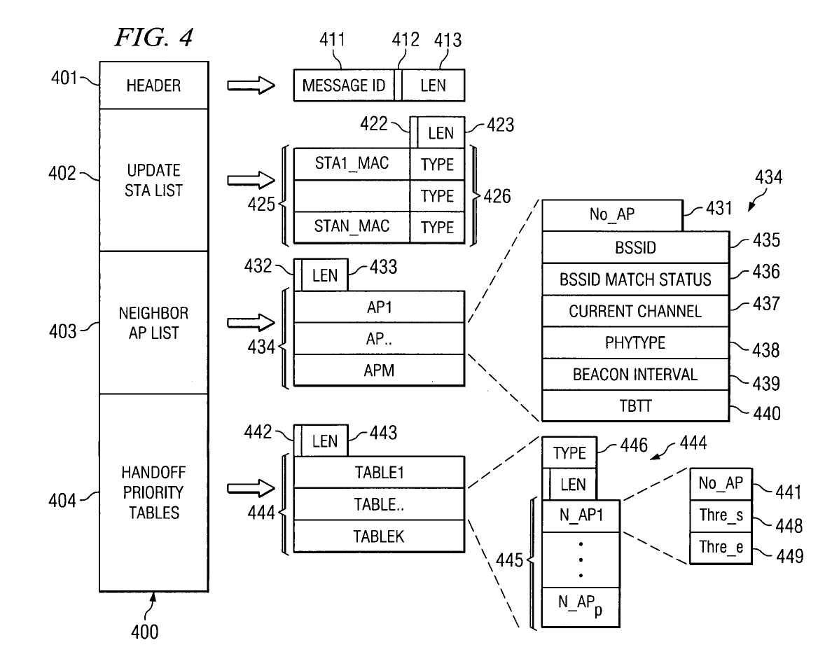

Turning to the neighbor reports of the present invention, embodiments of the present invention employ a neighbor report that is sent from an access point to its associated stations, either as a broadcast, or upon request by a station. FIG. 4 is a diagrammatic illustration of the contents of an embodiment of an efficient neighbor report such as may be used in accordance with embodiments of the present invention. Embodiment 400 of a neighbor report includes header 401, update station list 402, neighbor access point list 403, and handoff priority tables 404. Neighbor report 400 is preferably transmitted as a broadcast packet so that all station associated with the broadcasting access point can receive it.

Header 401 of neighbor report 400 may have a length of three octets. First octet 411 may be a message ID which informs a receiving station of the type of message, i.e. a neighbor report. Two most significant bits (MSB) 412 of the following two octets may be used as status bits. For example, if the 2 MSB are set to ‘00’, it may represent that the report is a complete neighbor report. If the 2 MSB are set to ‘01’, it may represents that the report is an update neighbor report. When any station receives a complete neighbor report, it preferably overwrites any existing neighbor report it has saved. Preferably, when a station receives an update neighbor report, the station only partially overwrites its previously saved neighbor report, updating the previously saved neighbor report. The fourteen least significant bits (LSB) 413 of the second and third octet of the illustrated neighbor report are preferably used to indicate the length of neighbor report, preferably in units of octets.

Update station list 402 includes a list of updated stations. The MSB two bits 422 of first two octets of the illustrated embodiment indicates whether the list is a complete list or a list update. The LSB fourteen bits 423 of the illustrated embodiment are used to indicate the length of the station update list, preferably in units of octets. Each element of the update station list includes MAC address 425 of a station to be updated and assigned type of handoff priority table of this station 426. Whenever a station finds its MAC address in the update station list, the station preferably assigns the new handoff priority table to itself. In accordance with embodiments of the present invention information in the neighbor report is updated for a station when one of the following conditions is met: the station makes a new connection with the access point; the assigned access point has received a neighbor report request from the station; or the assigned type of handoff priority table of the station needs to be changed.

Neighbor access point list 403 provides information about neighboring access points. The MSB two bits 432 of first two octets of the illustrated embodiment indicate whether the list is a complete list or a list update. The LSB fourteen bits 433 of the illustrated embodiment are used to indicate the length of the neighbor access point list, preferably in units of octets. Within list 403 of the illustrated embodiment, each access point's entry 434 includes the access point's BSSID 435, BSSID match status 436, current channel 437, PHY Type 438, Beacon Interval 439 and TBTT 440. One standard representation of TBTT 440 employs six octets, as a value ranging from 0x000000 to 0xffffff and the beacon interval may range from 0x00 to 0xff. In accordance with embodiments of the present invention the TBTT may be normalized to a value from 0x000000 to 0x0000ff. Therefore, if it is known that the default value of the four most significant octets is 0, only two octets are needed to represent the TBTT. In other words, the time to the next beacon time (i.e., TBTT) should not be larger than a beacon interval. Therefore, in accordance with the present invention the TBTT may be normalize to the maximum value of a beacon interval (i.e., 0xff). Additionally, since in accordance with the illustrated embodiment the length of BSSID 435 of each access point is six octets, a number, No_AP, 431 with a length of one octet may be used in accordance with the present invention to indicate each access point in handoff priority tables 404 as No_AP 441. In this manner, five octets may be saved in neighbor report 400.

Handoff priority tables 404 might include various types of handoff priority tables 444 to address different types of applications that a station may be running, the moving speed of the station and/or the like. The MSB two bits 442 of first two octets of handoff priority tables 404 of the illustrated embodiment indicate whether the tables are a complete set or a table update. The LSB fourteen bits 443 of first two octets of handoff priority tables 404 of the illustrated embodiment are used to indicate the length of handoff priority tables 404, preferably in units of octets. Tables of embodiments of the invention may include an indication of the type 446 of table. In each table 444, a number of neighbor access points 445 is preferably provided and each of them is identified by an No_AP 441, as discussed above and preferably each neighbor access point has its own search threshold 448 and its own execution threshold 449. Preferably each station is assigned with one type of handoff priority table 444. In the extreme case, the number of types of handoff priority tables 444 is the same as that of stations.

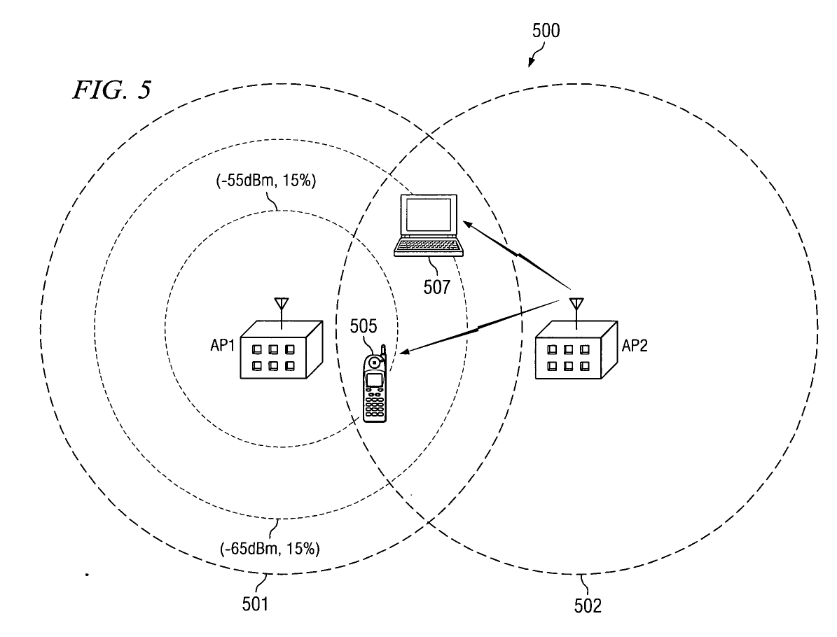

In accordance with embodiments of the present invention adaptive threshold for searching should be set with the consideration of various factors, such as application type, overlapping area among different access points, moving speed of the station and/or the like. In accordance with embodiments of the present invention, the search thresholds may be measures of signal strength, error rates and/or other measures of link quality. FIG. 5 is a diagrammatic illustration of embodiment 500 of the use of adaptive thresholds for searching, such as threshold 448, according to embodiments of the present invention. This threshold may be adapted according to the application a station is running, the speed the station is moving, etcetera, at a given time. FIG. 5 shows various thresholds for searching according to application type, with stations 505 and 507 moving from AP1 coverage area 501 to AP2 coverage area 502. Station 505, running a voice application, may employ a threshold of −55 dBm for a Received Signal Strength Indicator (RSSI) and 15 percent Frame Error Rate (FER), while station 507, running a data application, might employ a threshold of −65 dBm RSSI and 15 percent FER. Similarly, a station moving at a high rate of speed may employ a higher threshold, such as the illustrated −55 dBm RSSI and 15 percent FER threshold, while a slower moving station might employ the lower −65 dBm RSSI and 15 percent FER threshold to initiate searching.

With the assumption of a cell radius of 500 meters and use of the above indicated thresholds, table 1 shows the percentage of local traffic used for search with different number of voice and data users, in accordance with embodiments of the present invention.

TABLE 1
Percentage of Local Traffic Used for Search

| Number of | Without adaptive | With adaptive |
|---|---|---|
| Voice, Data STAs | threshold | threshold |
| (20, 30) | 17.6% | 7.5% |
| (10, 40) | 23.5% | 10.1% |

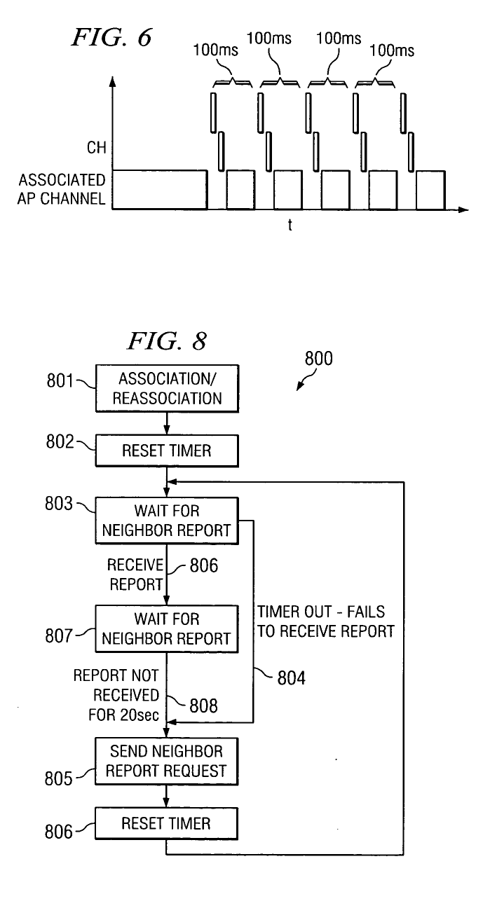

As noted, using passive search schemes, based on listening for beacons sent by non-associated access points, introduces a delay, intolerable to many applications. In accordance with embodiments of the present invention, since each access point transmits its beacon periodically, a station may use a TBTT of neighboring access point(s), such as TBTT 539 of report 500, to selectively monitor non-associated channels to capture an access point's beacon, SAT, pilot signal , or the like, to gather or confirm information about the access point and/or to determine potential link quality with that access point. FIG. 6 is a diagrammatic illustration intended to show how the station has increased usable time on its associated channel while scanning for a handoff access point using TBTT, relative to conventional passive searching, as shown in FIG. 2. In this manner, a station may rely on a passive searching scheme with reduced extra cost of throughput on its present channel, relative to existing passive searching techniques. Additionally, bandwidth load on non-associated access points may be reduced due to a reduction in the need for active searching.

As noted above a conventional active search is based on a station sending a probe request packet and an access point sending a probe response packet back upon receiving the probe request packet. This active search may be used to acquire information about an access point and the station can estimate the link quality based on a received SNR of the probe response packet. However, with a neighbor report of the present invention a station has all information about neighboring access points except the link quality it might have with each of these access points. Therefore, systems employing embodiments of the present invention may not need to employ conventional active searching to acquire information about a potential handoff access point. Therefore, in accordance with the present systems and methods a station can send a null packet with the destination address of a neighboring access point. On receiving this null packet, the neighboring access point's MAC will preferably and automatically return an ACK packet within 10 us. The station can estimate link quality based the SNR, or the like of the received ACK. In this manner, the time used for an active search can be reduced to about 1 ms compared with tens of ms using the conventional probe request scheme. Since the length of ACK is much less than that of probe response, the air time and bandwidth occupied by an active search is also reduced significantly, thereby enhancing overall system capacity.

During the handoff execution phase the present systems and methods might employ adaptive threshold for executing 449, such as may be contained in neighbor report 500. With the knowledge of neighboring access point information provided by a neighbor report, and link quality to the access point(s), a station might compare its current link with other links, such as in terms of SNR of each link. If the difference of a new link SNR and the current link SNR is larger than a certain threshold, such as execution threshold 449 for an access point, the station might try to switch to the other access point. Due to the fluctuation of wireless channels, the larger the threshold, the more likely the new link is better than the current link. However, the higher the threshold, the more likely that a station may lose the connection with a current access point before it makes a new connection with a new access point which can generate a large hand-off delay. Thus, in accordance with the present invention a station employing a voice application is preferably assigned a lower threshold, while the same station in the same location, running a data application might be provided a higher threshold.

FIG. 7 shows various execution thresholds according to application type, with stations 705 and 707 moving from AP1 coverage area 701 to AP2 coverage area 702. Station 705, running a voice application, may employ a relatively lower threshold of 15dB for a SNR of the new access point, AP2, and a difference in SNR (delta SNR) between the currently associated access point, AP1, and the target access point , AP2, of 3 dB, to determine if it will execute an access point handoff. This threshold more likely insures that minimal delay will exist in a link with the new access point, AP2. Meanwhile, station 707, running a data application, might employ a relatively higher threshold of 10 dB SNR and a delta SNR of 6 dB, to determine if it will execute an access point handoff. This threshold more likely insures that the link will maintain integrity. In a similar fashion, a station moving at a high rate of speed may employ a lower execution threshold, such as the illustrated 15 dB SNR and 3 dB delta SNR, while a slower moving station might employ the higher 10 dB SNR and 6 dB delta SNR threshold to initiate a switch.

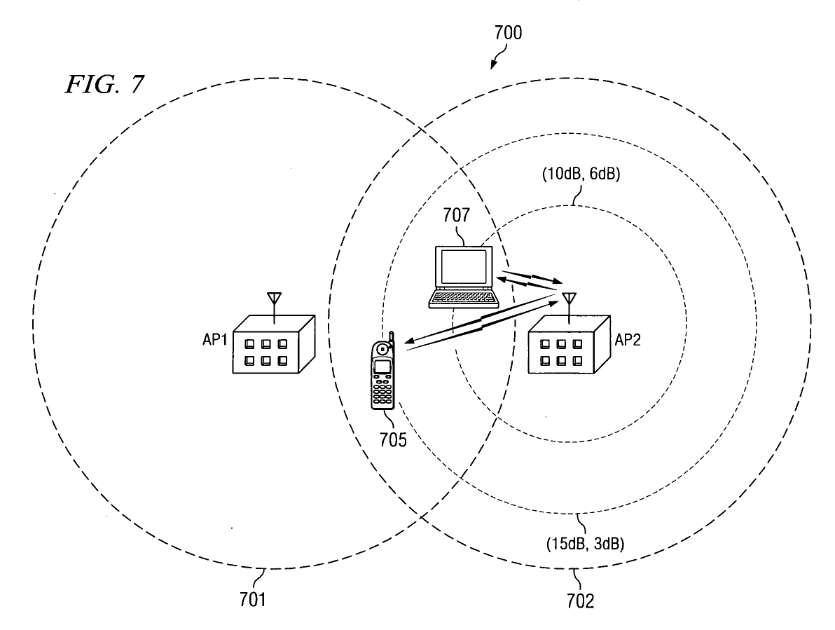

Returning to the neighbor report, FIG. 8 is a flow diagram of embodiment 800 of a method for obtaining a neighbor report by a station. When a station makes a new connection with an access point, i.e. associate or re-associate with an access point, at 801, the station resets a timer at 802 and begins to count the time. At 803 the station waits for a neighbor report. If the station fails to receive a neighbor report within two seconds (804), the station requests a neighbor report from its associated access point at 805. Then the station resets its timer and switches back to waiting for a neighbor report at 803. If the station successfully receives neighbor report in two seconds (806), the station switches to another state and waits for any new neighbor report or update at 807. However if the station fails to receive a neighbor report or update for a long period of time, e.g. 20 seconds, (808) the station will request a neighbor report at 805. In this manner a station maintains a current picture of the neighboring potential handoff access points, without tying-up bandwidth of the neighboring access points.

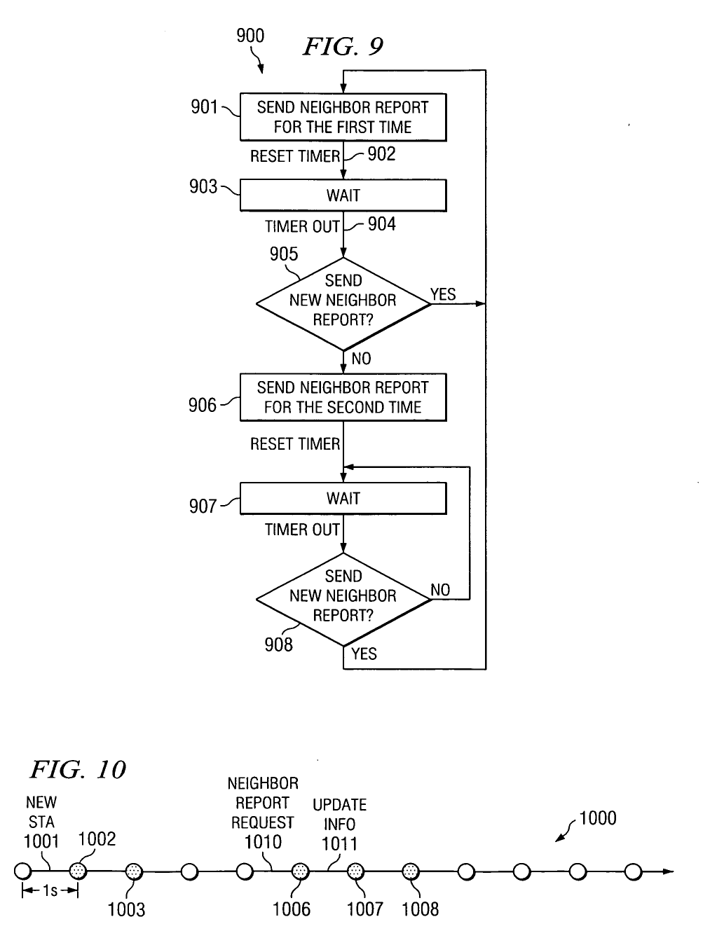

FIG. 9 is a flow diagram of an embodiment of method for transmitting a neighbor report by an access point. At 901 the access point sends out a neighbor report for the first time, resets a timer at 902 and waits at 903. If within the next second it is determined at 904 that any content of the neighbor report needs to be updated the access point sends a new neighbor report at 901, otherwise the access point resends the same neighbor report at 906 for a second time. Since the present systems and methods broadcast the neighbor report, there should not be an acknowledgement of reception from the stations. Therefore, the neighbor report is preferably resent at 906 to increase the probability that the neighbor report is received by all the appropriate stations. At 907 the access point waits for another second. If it is determined at 908 that a neighbor report needs to be updated within the second second, the access point sends a new neighbor report at 901, otherwise the access point suspends the transmission of neighbor report and waits at 907 another second. In this manner an access point can keep its assigned stations updated on the neighboring potential handoff access points, without the need for the stations to tie up bandwidth of the neighboring access points. Additionally or alternatively, an access point may transmit, or unicast, a neighbor report to a single station which needs a neighbor report or transmit/unicast a neighbor report update to a single station that needs such an update.

Taking the method embodiments of FIGS. 8 and 9 together, FIG. 10 shows timeline 1000 for transmission and reception of neighbor reports from an access point to a new station in that access points coverage area, added at 1001. The time increments between the points on the timeline are, by way of example, one second. At times 1002, 1003, 1006, 1007 and 1008 neighbor reports are sent. The report at 1002 is sent because the new station has joined the access point within the last second. The report at 1003 is preferably sent for a second time for the reasons discussed above in relation to step 906 of FIG. 9, to increase the probability that the neighbor report is received by all the appropriate stations. The report sent at 1006 was sent because the station requested a report at 1010 and the report at 1007 was sent because there had been an update to data pertinent to the station at 1011. The update report is preferably resent at 1008, also for the reasons discussed above in relation to step 906 of FIG. 9, to increase the probability that the neighbor report update is received by all the appropriate stations. Additionally or alternatively, as discussed above, the transmissions may take the form of a broadcast to all stations in a access point's coverage area or the transmissions may take the form of a unicast to individual stations in need of a neighbor report or an update neighbor report.

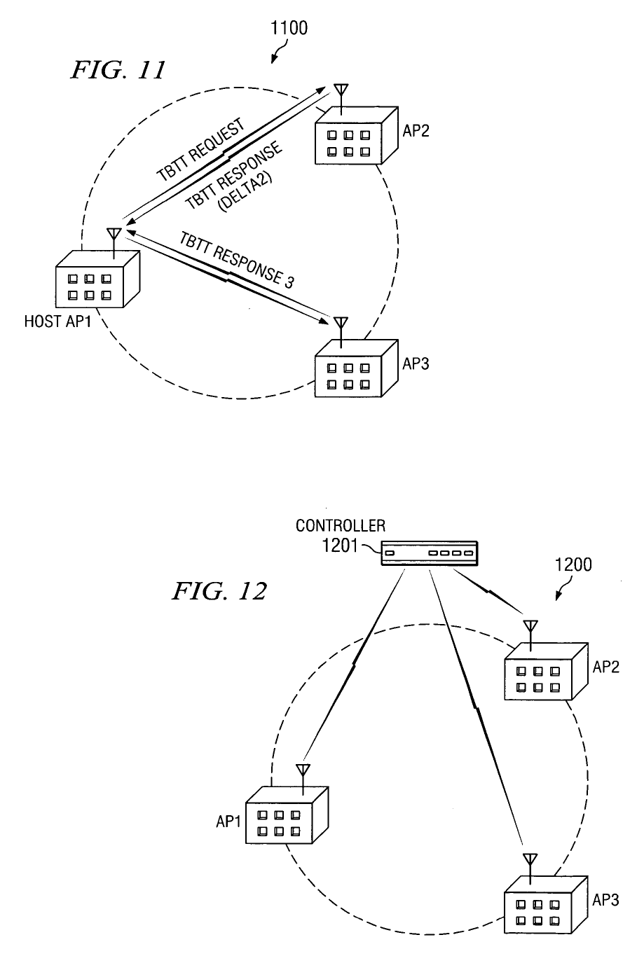

FIGS. 11 and 12 are diagrammatic illustrations showing how TBTT may be obtained from access points for inclusion in neighbor reports. FIG. 11 is diagrammatic illustration of an embodiment of system 1100 employing an ad-hoc method embodiment for acquiring the TBTT of an access point. In system 1100 several access points AP1, AP2, AP3) share a distributed system which may take the form of a wireline distribution system or a wireless distribution system, without a central controller. By way of example, when AP1 wants to know the TBTT time of AP2, AP1 might send a TBTT request directly to AP2, at time TS01. Upon receiving the request, AP2 preferably sends a response packet with its current time stamp (TS2) and the time remaining (delta2) until its next beacon transmission. AP1 receives the response packet from AP2 and AP1 at time TS02 and can calculate the round-trip time(RTT) between AP1 and AP2, as RTT2=TS02-TS01. AP1 may assume that delay for each direction is the same and AP1 can estimate the TBTT time of AP2 as TBTT'2=TS02+delta2-RTT2/2

FIG. 12 is diagrammatic illustration of an embodiment of system 1200 employing a central controller-based embodiment for acquiring the TBTT of an access point. System embodiment 1200 includes a central controller 1201, which can be used to synchronize the access points (AP1, AP2, AP3) and inform each access point of the other access points' TBTTs for inclusion in neighbor reports.

Although the present invention and its advantages have been described in detail, it should be understood that various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one will readily appreciate from the disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A wireless network neighbor report comprising:
target beacon transmission times of neighboring access points.

2. The neighbor report of claim 1 further comprising at least one adaptive threshold.

3. The neighbor report of claim 2 wherein said adaptive threshold is based on at least one of a type of application being run by said station, a moving speed of said station, a target handoff access point and an associated access point.

4. The neighbor report of claim 2, further comprising:
handoff priority tables.

5. The neighbor report of claim 4, wherein said at least one adaptive threshold is contained in said handoff priority tables.

6. The neighbor report of claim 4 wherein each of said handoff priority tables is associated with a station assigned to an access point transmitting said neighbor report.

7. The neighbor report of claim 1 further comprising a plurality of adaptive thresholds, at least one of said thresholds being a search threshold and at least one of said thresholds being an execution threshold.

8. The neighbor report of claim 1 wherein said neighbor report contains more information that a IEEE 802.11k site report.

9. A method comprising:
broadcasting a neighbor report, by a wireless data access point, to associated wireless data stations, said neighbor report comprising information about neighboring access points; and
updating said neighbor report by broadcasting an update to said neighbor report to said associated wireless data stations.

10. The method of claim 9 further comprising:
unicasting a neighbor report to one of said stations needing a neighbor report.

11. The method of claim 9 further comprising:
updating said neighbor report for one of said stations by unicasting an update to said neighbor report to the one station.

12. The method of claim 9 wherein said neighbor report includes target beacon transmission times of neighboring access points.

13. The method of claim 12 further comprising:
searching, by a station, for a target handoff access point by scanning said neighboring access points at said target beacon transmission times.

14. The method of claim 13 wherein said scanning comprises:
receiving, by said station, a beacon from said neighboring access points during said target beacon transmission times.

15. The method of claim 9 further comprising:
searching, by a station, for a target handoff access point by sending a null packet to a target access point and measuring acknowledgment signals from said target access point.

16. The method of claim 9 wherein said neighbor report comprises an adaptive threshold used by said stations to determine if a station should initiate searching for a target handoff access point.

17. The method of claim 16 wherein said adaptive threshold is based on at least one of a type of application being run by said station, a moving speed of said station and an associated access point.

18. The method of claim 9 wherein said neighbor report also comprises an adaptive threshold used by said stations to determine if a station should establish a connection with a target access point.

19. The method of claim 18 wherein said adaptive threshold is based on at least one of a type of application being run by said station, a moving speed of said station and a target handoff access point.

20. A system comprising:
a plurality of wireless data access points, each of said access points providing a neighbor report to its assigned stations, said neighbor report comprising information about neighboring access points, including target beacon transmission times.

21. The system of claim 20 further comprising:
a plurality of stations adapted for wireless communication with said access points, each of said stations associated with one of said access points, and searching for a target handoff access point by scanning channels associated with said neighboring access points at said target beacon transmission times.

22. The system of claim 20 further comprising:
a plurality of stations adapted for wireless communication with said access points, each of said stations associated with one of said access points, and adapted to search for a target handoff access point by transmitting a null packet to one of said access points and monitoring a strength of an acknowledgment signal to probe the signal strength of the one access point.

23. The system of claim 20 wherein said neighbor report further includes an adaptive threshold, used by one of said assigned stations to initiate searching for a new access point for handoff.

24. The system of claim 23 wherein said adaptive threshold is based on at least one of a type of application being run by said station, a moving speed of said station and an associated access point.

25. The system of claim 23 wherein said stations employ an second adaptive threshold provided by said neighbor report to initiate execution of a handoff to a new access point.

26. The system of claim 25 wherein said second adaptive threshold is based on at least one of a type of application being run by said station, a moving speed of said station and a target handoff access point.

27. The system of claim 20 wherein said neighbor report contains more information that a IEEE 802.11k site report.

28. A wireless data access point comprising:
means for broadcasting a neighbor report, said neighbor report comprising information about neighboring access points, said information comprising:
target beacon transmission times of said neighboring access points;
an adaptive searching threshold for a particular station associated with an access point to initiate searching for a handoff access point; and
an adaptive execution threshold for said particular station to initiate execution of a handoff to a particular access point.

29. The access point of claim 28 wherein said neighbor report contains more information that a IEEE 802.11k site report.

30. The access point of claim 28 wherein said adaptive thresholds is based on at least one of a type of application being run by said station, a moving speed of said station, an associated access point of said station, and a target handoff access point.

31. The access point of claim 28 wherein said neighbor report comprises handoff priority tables and said adaptive threshold are contained in said handoff priority tables associated with said particular station.

32. The access point of claim 28 wherein said neighbor report comprises handoff priority tables and said adaptive execution threshold is contained in one of said handoff priority tables associated with said particular station and said particular access point.

33. A wireless station comprising:
means for receiving a neighbor report and a neighbor report update from an associated access point; and
means for updating said neighbor report based upon update information contained in said neighbor report update.

34. The wireless station of claim 33, further comprising:
means for searching for a target handoff access point when an adaptive searching threshold is breached.

35. The wireless station of claim 34 wherein said means for searching comprises:
means for receiving beacons from neighboring access points during target beacon transmission times for said neighboring access points contained in said neighbor report; and
means for sending a null packet to said neighboring access points; and
means for measuring acknowledgment signals from said neighboring access points.

36. The wireless station of claim 34 wherein said adaptive thresholds are based on at least one of a type of application being run by said station, a moving speed of said station, said associated access point and said target handoff access point.

37. The wireless station of claim 33, further comprising:
means for executing a handoff to a target access point when an adaptive execution threshold contained in said neighbor report is breached.
